(19) United States
(12) Patent Application Publication
(10) Pub. No.: US 2023/0205626 A1
(43) Pub. Date: Jun. 29, 2023

(54) MULTILEVEL MEMORY FAILURE BYPASS

(71) Applicant: Intel Corporation, Santa Clara, CA (US)

(72) Inventors: Rubén Salvador HERNÁNDEZ CORTÉS, Zapopan (MX); Gaurav PORWAL, Portland, OR (US); Omar AVELAR SUAREZ, Zapopan (MX); Theodros YIGZAW, Sherwood, OR (US)

(21) Appl. No.: 18/116,785

(22) Filed: Mar. 2, 2023

(51) Int. Cl. G06F 11/10; G06F 11/07

(52) U.S. Cl. CPC G06F 11/1064; G06F 11/0787; G06F 11/076

(57) ABSTRACT

Multilevel memory error management techniques can improve system performance, availability, and reliability by preventing future accesses to faulty near memory locations. According to examples described herein, multilevel memory error management techniques enable proactively offlining far memory locations mapped to a faulty near memory location before additional faults are encountered, and/or maintaining a faulty near memory location list to enable bypassing the faulty near memory location to prevent future errors.

### FIELD

Descriptions are generally related to multilevel memory, and more particular descriptions are related to techniques for managing errors in multilevel memory.

### BACKGROUND

A multilevel memory is a memory hierarchy with at least two levels of memory. Typically, the different levels of memory have different attributes, such as access time and capacity. In one example, a two-level main memory can include a first level volatile memory and a second level persistent memory. The second level is presented as “main memory” to the host operating system while the first level is used as a cache for the second level. In one example, the second level is the last level of the system memory hierarchy and the first level duplicates and caches a subset of the second level.

### BRIEF DESCRIPTION OF THE DRAWINGS

The following description includes discussion of figures having illustrations given by way of example of an implementation. The drawings should be understood by way of example, and not by way of limitation. As used herein, references to one or more examples are to be understood as describing a particular feature, structure, or characteristic included in at least one implementation of the invention. Phrases such as “in one example” or “in an alternative example” appearing herein provide examples of implementations of the invention, and do not necessarily all refer to the same implementation. However, they are also not necessarily mutually exclusive.

FIG. 1 is a block diagram of an example of a conventional technique of handling an error in a near memory location.

FIGS. 2A-2D illustrate block diagrams of a system and elements of the system in which multilevel memory error management techniques can be implemented.

FIG. 3 is a flow chart of a method of a multilevel memory error management technique.

FIG. 4 illustrates a block diagram of an example of a multilevel memory error management technique using an enhanced firmware log.

FIG. 5 illustrates a block diagram of an example of a multilevel memory error management technique in which the operating system determines which far memory locations to offline.

FIG. 6 illustrates a block diagram of a memory controller including a faulty near memory location list.

FIG. 7 illustrates a flow chart of an example of a method of multilevel memory error management technique using a faulty near memory location list.

FIGS. 8A and 8B illustrate block diagrams of an example of a multilevel memory error management technique using a faulty near memory location list.

FIG. 9 is a block diagram of an example of a system with a memory subsystem having near memory and far memory with an integrated near memory controller and an integrated far memory controller.

FIG. 10 is a block diagram of an example of a computing system in which multilevel memory error management techniques can be implemented.

Descriptions of certain details and implementations follow, including non-limiting descriptions of the figures, which may depict some or all examples, and well as other potential implementations.

### DETAILED DESCRIPTION

As described herein, multilevel memory error management techniques can improve system performance, availability, and reliability by preventing future accesses to faulty near memory locations. According to examples described herein, multilevel memory error management techniques enable proactively offlining far memory locations mapped to a faulty near memory location before additional faults are encountered, and/or maintaining a faulty near memory location list to enable bypassing the faulty near memory location to prevent future errors.

Multilevel memory for technologies such as data center persistent memory modules (DCPMM) or upcoming memory pools for data center servers play a crucial role in memory scaling. However, faults in the intermediate memory hierarchy of a multilevel memory can have a significant impact on platform reliability and server uptime. For example, a fault in the intermediate memory hierarchy can warrant the offlining of multiple far memory locations or pages when there are multiple locations in far memory mapped to a single location in near memory. For example, in a memory hierarchy with an 8:1 (Far Memory:Near Memory) mapping ratio, a fault in near memory would typically result in encountering errors when accessing 8 far memory pages.

In one such example, platform firmware notifies the operating system of errors encountered when accessing a location in far memory. Conventional platform firmware schemes only report the single far memory address that is mapped to the faulty near memory hierarchy and hence the operating system has the ability to offline one of the 8 possible pages in the far memory. Each subsequent access to another far memory location mapped to the faulty near memory location results in an error.

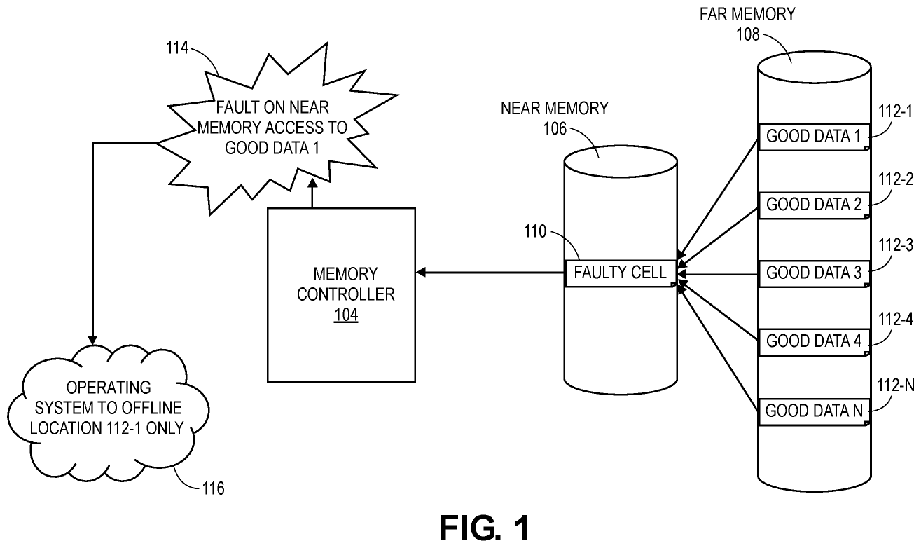

For example, FIG. 1 is a block diagram of an example of a conventional technique of handling an error in a near memory location. In the conventional solution, neither the platform firmware nor the operating system has the ability to predict future failures at the higher hierarchy memory location (e.g., in far memory). The system illustrated in FIG. 1 includes a memory hierarchy with a near memory 106 and a far memory 108. Multiple (N) far memory locations 112-1-112-N are mapped to a single near memory location 110.

FIG. 1 depicts an example in which the memory controller 104 receives a request to access Good Data 1 at far memory location 112-1. The memory controller 104 determines that Good Data 1 is stored in the near memory location 110 and sends the request to the near memory 106. The near memory location 110 is faulty (e.g., a fault or error is encountered at the near memory location 110), and thus returns an error to the memory controller 104. The memory controller 104 then notifies firmware of the fault 114 on the near memory access to Good Data 1, and the firmware notifies the operating system of the fault (e.g., via an error log identifying only far memory location 112-1). The operating system then offlines (at 116) the page at far memory location 112-1 where Good Data 1 is stored to prevent further accesses to far memory location 112-1. However, only offlining the far memory location 112-1 leaves the system exposed to N−1 additional errors (e.g., errors when far memory locations 112-2-112-N are accessed), reducing the reliability and availability of the platform.

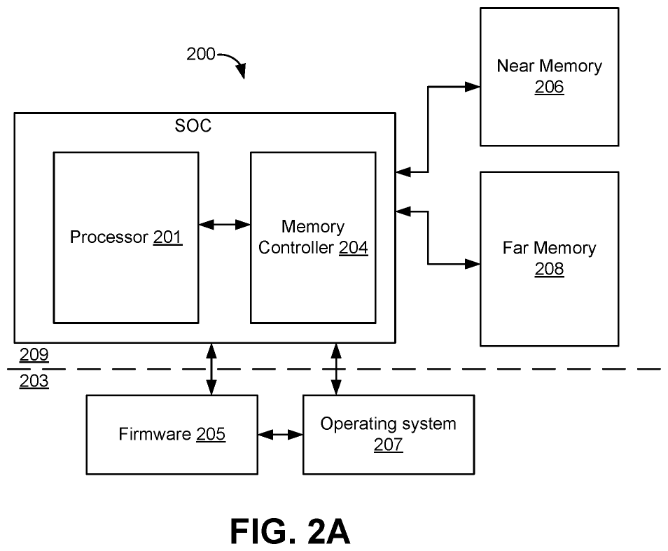

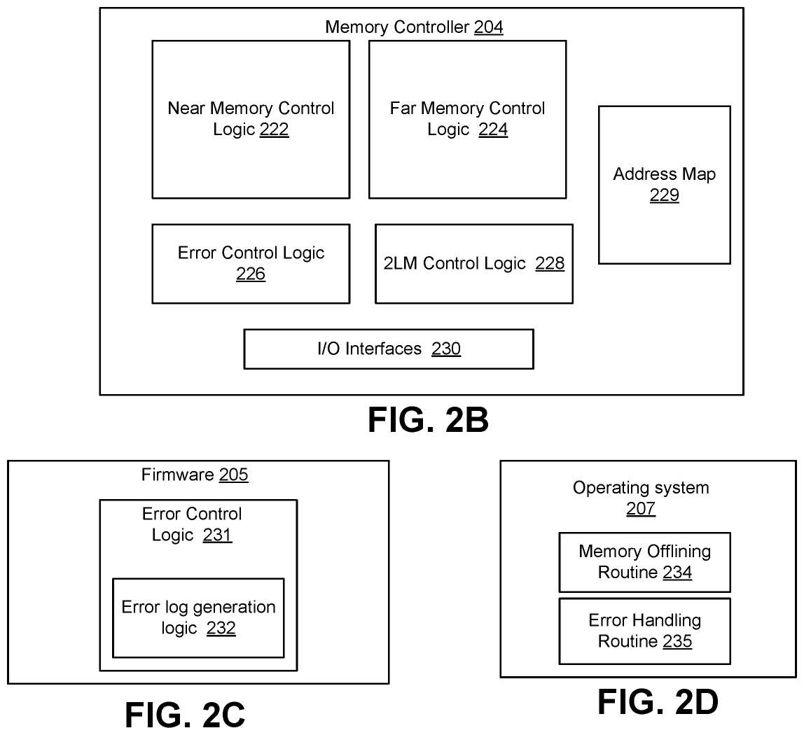

In contrast, multilevel memory error management techniques that prevent future accesses to faulty near memory locations can enable improved platform reliability and server uptime. FIGS. 2A-2D illustrate block diagrams of a system and elements of the system in which multilevel memory error management techniques can be implemented.

FIG. 2A is a block diagram of a system 200 or platform with a multilevel memory hierarchy, including a near memory 206 and a far memory 208. The system 200 includes hardware elements 209 and firmware and software elements 203. It will be understood that different or additional hardware, firmware, and software elements may be included in the system 200 other than what is illustrated in FIG. 2A.

The system includes a processor 201. The processor 201 represents computing or processing resources for the system 200 and can be understood generally as the component to execute an operating system that will manage a software environment to control the operation of the system 200. The processor 201 can represent any type of microprocessor, CPU, graphics processing unit (GPU), infrastructure processing unit (IPU), processing core, or other processing hardware to provide processing for compute platform, or a combination of processors. The processor 201 may also include an SoC or XPU. Processor 201 controls the overall operation of the system 200, and can be or include, one or more programmable general-purpose or special- purpose microprocessors, digital signal processors (DSPs), programmable controllers, application specific integrated circuits (ASICs), programmable logic devices (PLDs), or the like, or a combination of such devices.

The system includes a memory controller 204 coupled with and/or integrated in the processor 201. The term “coupled” can refer to elements that are physically, electrically, and/or communicatively connected either directly or indirectly, and may be used interchangeably with the term “connected” herein. Elements that coupled together may have intervening components to facilitate the exchange of signals. Physical coupling can include direct contact. Electrical coupling includes an interface or interconnection that allows electrical flow and/or signaling between components. Communicative coupling includes connections, including wired and wireless connections, that enable components to exchange data. The memory controller 204 includes control logic to generate and issue commands to memory (e.g., near memory 206 and/or far memory 208). It will be understood that the memory controller 204 could be a physical part of processor 201 or a physical part of an interface. For example, memory controller 204 can be an integrated memory controller, integrated onto a circuit with processor 201. The memory controller 204 may represent one or multiple memory controllers. For example, the system 200 can include a far memory controller that is distinct from a near memory controller, or a controller that controls both the near memory 206 and far memory 208. In one example, the system can include a multilevel memory controller (e.g., a 2LM controller). In one example, a system can include multiple levels of memory controllers (e.g., a 2LM controller that couples with a near memory controller and a far memory controller).

FIG. 2B illustrates a block diagram of an example of a memory controller 204. The memory controller 204 includes input/output (I/O) interfaces 230 to enable the memory controller 204 to interface with the processor 201, the near memory 206, and the far memory 208. For example, the memory controller 204 receives memory access requests from the processor 201 via an I/O interface (e.g., a host interface) and sends commands to memory via an I/O interface with the near memory 206 and/or far memory 208. The I/O interfaces 230 can include pins, pads, connectors, signal lines, traces, or wires, or other hardware to connect the devices, or a combination of these. The I/O interfaces can include a hardware interface. In one example, the I/O interfaces 230 include at least drivers/transceivers for signal lines. Commonly, wires within an integrated circuit interface couple with a pad, pin, or connector to interface signal lines or traces or other wires between devices. The I/O interfaces 230 can include drivers, receivers, transceivers, or termination, or other circuitry or combinations of circuitry to exchange signals on the signal lines between the devices. The exchange of signals includes at least one of transmit or receive. Note that although the I/O interfaces 230 are illustrated as a single block, the I/O interfaces represent multiple hardware interfaces for coupling with various signal lines, buses, links, and/or fabrics.

In the example illustrated in FIG. 2B, the memory controller 204 includes near memory control logic 222 to control and access the near memory 206, and a far memory control logic 224 to control and access the far memory 208. In one example, the near memory control logic 222 is a DRAM controller and the far memory control logic 224 is a non-volatile memory (NVM) controller. In one example, the near memory control logic 222 and the far memory control logic 224 include logic to generate and issue commands to the near memory and far memory, respectively.

In one example, the memory controller 204 includes 2LM control logic 228 to handle the routing of requests and responses to and from the near memory 206 and the far memory 208. In one example, the 2LM control logic operates similarly to a cache controller where the near memory 206 is operated as a cache for the far memory 208. In one example, the 2LM control logic 228 receives a memory access request and checks an address map 229 to determine whether the data at the far memory location is stored at a near memory location (e.g., whether the data is “cached” in near memory). In one such example, if the data is stored in near memory (“a hit”), the request is sent to near memory (e.g., via near memory control logic 222) and if the data is not stored in near memory (“a miss”), the request is sent to far memory (via far memory control logic 224). In one such example, the address map 229 is a lookup table in which the memory controller 204 tracks which far memory locations are mapped to a near memory location. In one example, the address map 229 can also store data to indicate which far memory location is currently stored in a given near memory location. The address map 229 can be stored in a separate storage location in the memory controller 204 (e.g., registers, SRAM, or other storage), in near memory 206, and/or in far memory 208. In one example, the mapping of far memory to near memory can be achieved via different techniques, such as with a tag array similar to a traditional cache tag array.

Referring again to FIG. 2A, the memory controller 204 is coupled with a multilevel memory including a near memory 206 and a far memory 208. In the illustrated example, the multilevel memory is a two-level memory (2LM); however, multilevel memories can include more than two levels. It will be understood that near memory and far memory do not necessarily refer to distance. In one example, the distinction between near memory and far memory can be average access time. System memory is typically an order of magnitude slower than on-board cache on the processor or on the CPU (central processing unit) SOC (system on a chip). System memory, in turn, is typically multiple order of magnitude faster than nonvolatile, long-term storage. System memory is traditionally implemented with volatile dynamic random access memory (DRAM) technology.

Volatile memory refers to memory whose state is indeterminate if power is interrupted, and thus cannot guarantee data integrity after an interruption of power. Nonvolatile memory maintains state even if power is interrupted. Traditional nonvolatile memory for storage is block access, while DRAM is byte-addressable. Emerging memory technologies provide byte- addressable nonvolatile memory that has access speeds comparable to DRAM, while still having slower average access. Such memory technologies can be incorporated into a memory subsystem with traditional volatile memory to have multiple levels of access speed. Thus, in one example, near memory refers to the memory with faster access time, and far memory refers to the memory with slower access time. For example, 2LM systems can include DRAM as near memory, and nonvolatile memory (such as three-dimensional crosspoint memory (e.g., 3DXP)) as far memory.

The system 200 includes an operating system 207 and firmware 205. The operating system 207 provides a software platform for execution of instructions (e.g., programs) in the system 200. In one example, the firmware 205 includes platform firmware. The firmware 205 includes low-level software (code) that provides an interface between the hardware of the system 200 and the operating system 207. In one example, the firmware 205 provides an interface between the memory controller 204 and the operating system 207 to report memory errors to the operating system.

For example, referring to FIG. 2C, the firmware 205 includes error control logic 231 to receive notification of memory errors from the memory controller. Error log generation logic 232 can then generate and provide a log identifying information about the error (e.g., location (e.g., address), type of error, error count, and/or other information related to the error) to the operating system 207. Referring to FIG. 2D, the operating system 207 includes an error handling routine 235 to handle errors and a memory offlining routine 234 to offline faulty memory locations. A routine (e.g., sub-routine, function, procedure, method, subprogram) is one or more sequences of code that are called or executed to perform some functionality. For example, the error handling routine 234 is a sequence of code to handle errors, such as memory errors identified in an error log from the firmware 205. The memory offlining routine 234 is a sequence of code to “offline” one or more memory locations. In one example, offlining a memory location involves making a memory location (e.g., a 4K page or other granularity of memory) unavailable for access. In one example, the memory offlining routine 234 copies data from the location to be offlined to another location, and then marks the location as unavailable, bad, or with some other designation to prevent further access to the memory location.

As mentioned above, in conventional systems, platform firmware notifies the operating system of the far memory location that experienced an error, and the operating system offlines only that far memory location.

In contrast, in accordance with examples described herein, after receiving notification of a memory error at a near memory location in response to a request to access a far memory location, firmware or the operating system determines the other far memory locations mapped to the same near memory location and the operating system offlines those far memory locations mapped to the same near memory location.

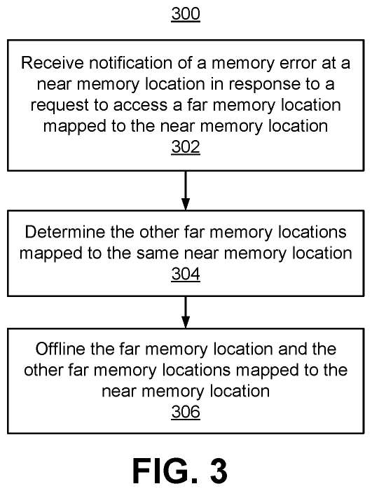

For example, FIG. 3 is a flow chart of a method of a multilevel memory error management technique. The method 300 of FIG. 3 can be performed by firmware (e.g., platform firmware, device firmware, the BIOS, and/or other firmware), software (e.g., an operating system and/or other software), or a combination of firmware and software.

The method 300 begins with receiving notification of a memory error at a near memory location in response to a request to access a far memory location mapped to the near memory location, at block 302. For example, referring to FIGS. 2A-2D, the firmware 205 receives a notification from the memory controller 204 that an error has occurred. The error or fault could be correctable or uncorrectable error. Typically, an uncorrectable error in near memory is deemed as correctable when a copy of the data is located in far memory. In one example, the memory controller 204 generates a machine check error or machine check exception (MCE) and signals the MCE to the firmware 205. The firmware 205 can then receive details about the error from the memory controller 204. For example, the firmware 205 can determine where (e.g., at which memory location in the memory hierarchy) the error occurred from the memory controller 204. In one example, the firmware 205 can determine the near memory location that caused the error and the far memory location being accessed that resulted in the error.

After receiving notification of the memory error, the method involves determining the other memory locations mapped to the same near memory location, at block 304. For example, referring to FIGS. 2A-2D, the firmware 205 can determine all far memory locations mapped to the faulty near memory location and generate an enhanced firmware log (e.g., via the firmware log generation logic 232). In another example, the operating system has access to the mapping information and can determine which far memory locations are mapped to a faulty near memory location.

After determining which far memory locations are mapped to the same faulty near memory location, the method involves offlining those far memory locations, at block 306. For example, the firmware sends an error log to the operating system to identify the far memory location and the other far memory locations to trigger offlining pages at those locations in the far memory. In one such example, offlining the far memory locations includes copying data at the far memory locations to other locations in the far memory, and making the far memory locations unavailable for access. Thus, in response to detection of an error in near memory, the firmware or operating system determine the other far memory locations mapped to the near memory location and the operating system offlines those far memory locations to prevent future errors due to repeated accesses to the same faulty memory location.

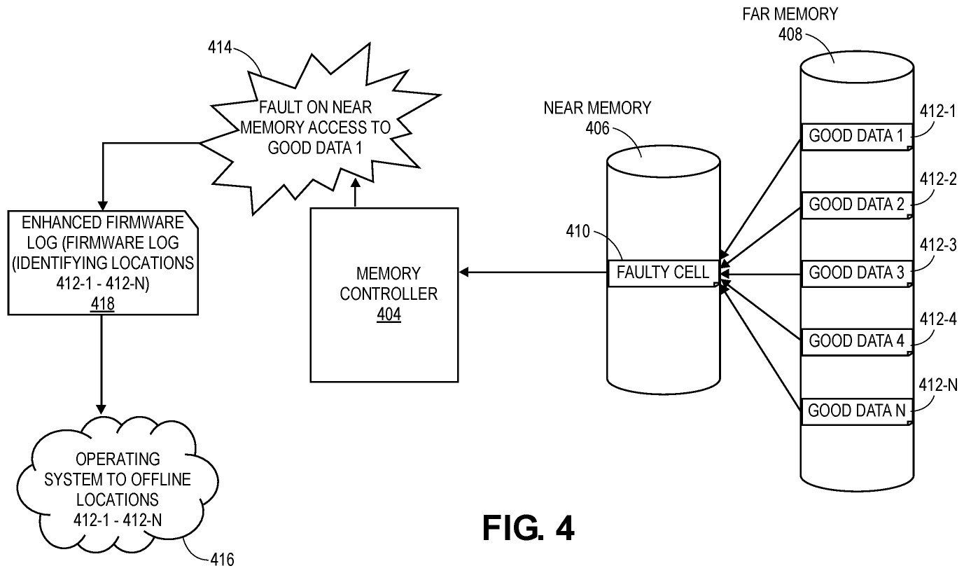

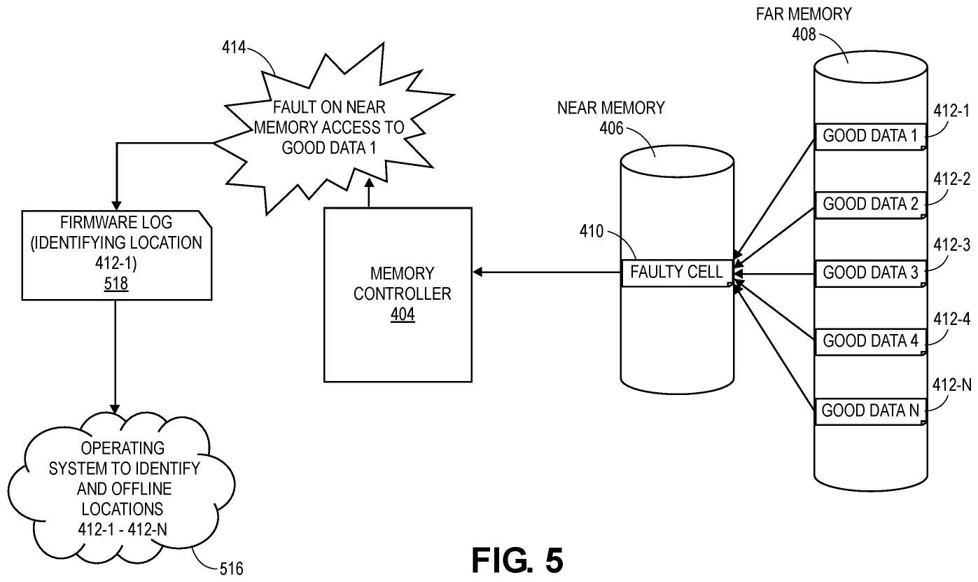

FIG. 4 illustrates a block diagram of an example of a multilevel memory error management technique using an enhanced firmware log. FIG. 5 illustrates a block diagram of an example of a multilevel memory error management technique in which the operating system determines which far memory locations to offline.

Turning first to FIG. 4, similar to FIG. 1, the system illustrated in FIG. 4 includes a memory hierarchy with a near memory 406 and a far memory 408. Multiple (N) far memory locations 412-1-412-N are mapped to a single near memory location 410.

FIG. 4 depicts an example in which the memory controller 404 receives a request to access Good Data 1 at far memory location 412-1. The memory controller 404 determines that Good Data 1 is stored in the near memory location 410 (e.g., by checking the address map 229) and sends the request to the near memory 406 for servicing. The near memory location 410 is faulty (e.g., a fault or error is encountered at the near memory location 410), and thus returns an error to the memory controller 404. The memory controller 404 then notifies firmware (e.g., the firmware 205 of FIG. 2C) of the fault or error 414 on the near memory access to Good Data 1.

In one example, unlike conventional techniques, instead of notifying the operating system of an error at only the far memory location 412-1, the firmware (e.g., firmware 205 of FIG. 2C) determines the other far memory locations 412-2-412-N mapped to the faulty near memory location 410. The firmware then generates an enhanced firmware log 418 that identifies the far memory locations mapped to the faulty near memory location 410. For example, referring to FIG. 2C, the error log generation logic 232 generates an enhanced firmware log that indicates that the multiple far memory locations 412-1-412-N that are mapped to the near memory location where the error was encountered. The firmware 205 then provides the enhanced firmware log to the operating system (e.g., the firmware 205 sends the enhanced firmware log or the operating system retrieves the enhanced firmware log). The operating system then offlines (at 416) the pages at all the far memory locations 412-1-412-N identified in the enhanced firmware log to prevent further accesses to far memory location 412-1-412-N, and thus prevent further access to the faulty near memory location 410.

Thus, instead of notifying the operating system of the error associated with only that single far memory location, the firmware determines other far memory locations mapped to the same faulty near memory location and enhances the notification messages to the operating system to include all possible far memory locations so that OS can re-use existing algorithms to offline those locations. The scheme described with respect to FIG. 4 would avoid future access to the faulty memory hierarchy without requiring changes to the operating system or hardware.

In another example, the firmware provides a standard log identifying the far memory location being accessed when the error occurred, and the operating system is capable of determining the other far memory locations mapped to the same near memory location identified in the log. For example, FIG. 5 illustrates a block diagram of an example of a multilevel memory error management technique in which the operating system identifies the additional far memory locations mapped to the faulty near memory location. In one such example, firmware receives notification of a memory error (e.g., fault or error 414) at a near memory location in response to a request to access a far memory location that is mapped to the faulty near memory location. In the example illustrated in FIG. 5, when the firmware receives notification of the fault or error 414, and instead of determining all the far memory locations mapped to the near memory location 410, the firmware sends a log 518 that identifies only the far memory location 412-1 for which the error was encountered. The operating system 516 then identifies the other far memory locations 412-2-412-N and offlines those far memory locations.

For example, referring to FIGS. 2C-2D, the error handling routine 235 of the operating system 207 receives the log 518 from the firmware 205. The error handling routine 235 then accesses address mapping information to determine which other far memory locations are mapped to the near memory location. In one example, the operating system determines a mapping ratio of near memory locations to far memory locations to determine the number of far memory locations mapped to a single near memory location. The operating system then determines the number of pages to offline based on the mapping ratio. For example, in FIG. 5, there are N pages mapped to a single near memory location (for a ratio of N:1), and therefore the operating system determines that it will offline N far memory locations. The operating system then checks an address map (e.g., the address map 229 of FIG. 2B) or calculates the other far memory addresses based on the near to far memory ratio to determine the far memory locations mapped to the faulty near memory location. The memory offlining routine 234 can then offline the identified far memory locations to prevent further access to the faulty near memory location 410.

Thus, in the example illustrated in FIG. 5, the operating system has access to the address map information and can offline all the far memory locations mapped to the near memory location in response to receiving notification of an error. In one such example, the firmware sends an error log indicating an error occurred in response to an access to a far memory location. The operating system checks the address map for all far memory locations mapped to the faulty near memory location, and offlines those pages to prevent future accesses to the faulty near memory location. In one example, the technique described in FIG. 4 provides for a mechanism to implement an algorithm change in the page offlining code in the Operating System (e.g., Linux Kernel, Windows, or other operating system) to calculate and offline all possible far memory locations by maintaining current platform firmware error reporting scheme. In one such example, the change to the page offlining code can be deployed as a hot-fix and may not require a data center scale system reboot.

One downside of schemes described in FIGS. 3-5 is the loss off far memory locations and potential page migration. In one such example, the offlined far memory locations would still be usable but mapped out from software, which translates to resource spillage due to a bad memory unit in the system. The following equation rearticulates the memory spillage:

Total Memory spillage=(Far Memory to Near memory Ratio)*Faulty NM Cells count

Accordingly, referring again to the flow chart of FIG. 3, the examples in FIGS. 4 and 5 illustrate two different techniques for performing the method 300 of FIG. 3. In the technique illustrated in FIG. 4, the firmware determines the other far memory locations mapped to the same faulty near memory location. In the technique illustrated in FIG. 5, the operating system determines the other far memory locations mapped to the same faulty near memory location.

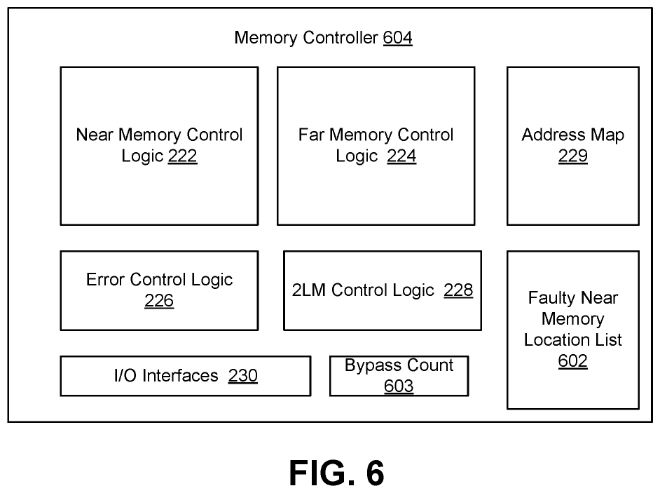

In another example, hardware logic (such a logic of a memory controller) stores faulty near memory locations in a list. When subsequent requests are received to access a far memory location that are mapped to a near memory location in the list, the near memory is bypassed, and the request is sent to the far memory location. For example, FIG. 6 illustrates a block diagram of a memory controller 604 including a faulty near memory location list 602. In one example, the list 602 stores information to identify locations in near memory where an error has occurred. Note that the term “list” as used herein does not imply any specific ordering of information; a list of near memory locations is stored information to identify two or more near memory locations. In one example, the list includes information to indicate near memory locations that are faulty and/or near memory locations that are to be bypassed.

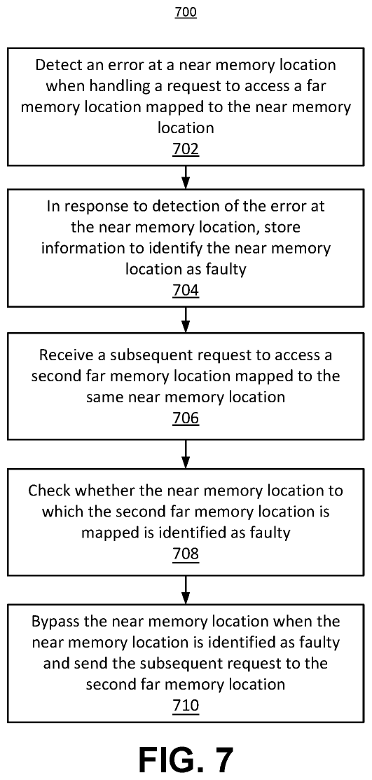

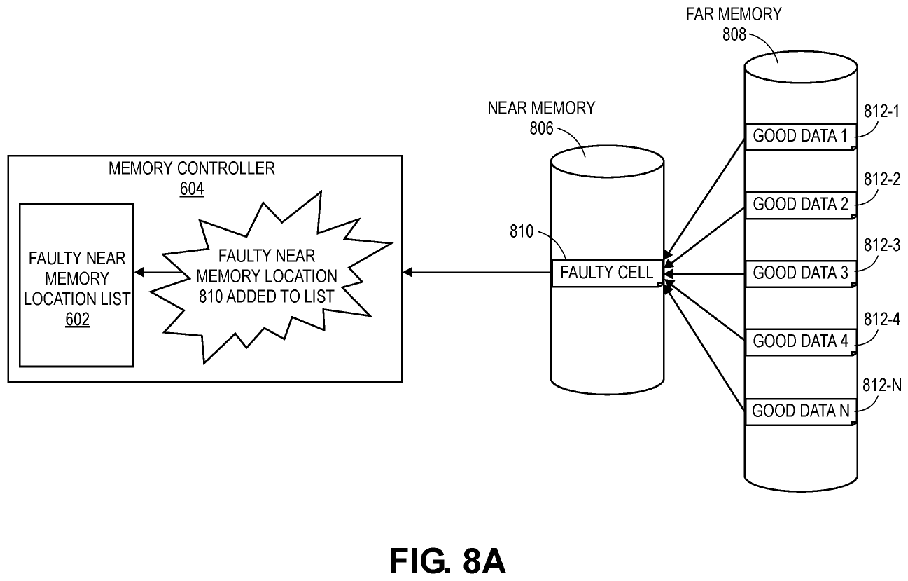

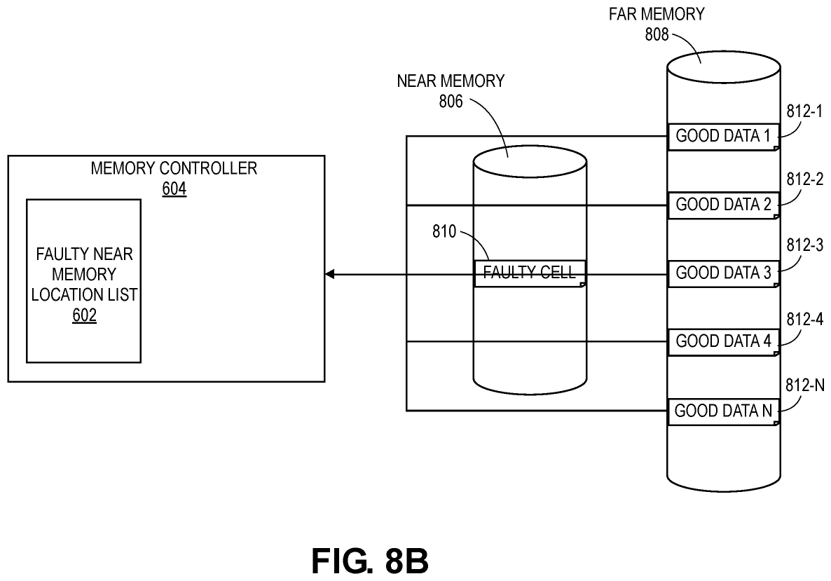

In one such example, the list stores the lower address (e.g., lower bits of the addresses in far memory locations that map to the near memory location) that would be stored at the faulty near memory location. In one such example, the far memory locations are directly mapped to near memory such that each far memory location maps to one near memory location based on the lower address bits of the far memory location. In one such example, the near memory location to which a given far memory location is mapped can be calculated (e.g., using the modulo operator and/or with another direct mapping technique). In one example, the list 602 is stored in a region in the near memory. In another example, the list 602 is stored in memory or storage of the memory controller 604 (e.g., registers, SRAM, or other hardware storage). FIG. 7 illustrates a flow chart of an example of a method 700 of multilevel memory error management technique using a faulty near memory location list. The method 700 can be performed by hardware logic (e.g., circuitry) of one or more memory controllers, microcode or firmware, or a combination thereof. FIGS. 8A and 8B illustrate block diagrams of an example of a multilevel memory error management technique using a faulty near memory location list. The method 700 of FIG. 7 will be described with references to FIGS. 8A and 8B.

Turning first to FIG. 7, the method 700 begins with detecting an error at a near memory location when handling or servicing a request to access a far memory location that is mapped to the near memory location, at block 702. For example, referring to FIGS. 6 and 8A, the memory controller 604 receives a request from a processor or other requestor to access a location 812-1 in far memory 808, which is mapped to the location 810 in near memory 806. The memory controller 604 encounters an error or fault in the near memory location 810 in response to a request to access the far memory location mapped to the near memory location. In one example, the error encountered is an uncorrectable error in near memory, or a correctable error in near memory that has caused a correctable error threshold overflow. Referring again to FIG. 7, the memory controller then stores information identifying the near memory location as faulty, at block 704. For example, referring to FIGS. 6 and 8A, the error control logic 226 of the memory controller detects the error and stores information in the list 602 indicative of the faulty near memory location 810 to which the far memory location 812-1 is mapped. In one such example, storing the information to identify the near memory location as faulty involves storing a value in one or more registers to identify that the near memory location is faulty. In one such example, one or more registers store information to represent the list 602. In one example, the near memory location is added to the list when either an uncorrectable error is encountered in near memory, or when the number of correctable errors at the near memory location have exceeded a threshold.

Referring again to FIG. 7, the method 700 involves receiving a subsequent request to access a second far memory location mapped to the same near memory location, at block 706. For example, referring to FIGS. 6 and 8B, the memory controller receives a request to access a different far memory location mapped to the same near memory location 806. For example, the memory controller receives a request to access far memory location 812-2 (or any of far memory locations 812-2-812-N). Referring again to FIG. 7, the method 700 then involves checking whether the near memory location to which the second far memory location is mapped is identified as faulty, at block 708. In one such example, and referring to FIG. 6, checking whether the near memory location is identified as faulty involves checking whether the near memory address is in the list 602. In one such example, the near memory address is in the list 602 if information indicative of the near memory address is stored in some hardware storage (such as one or more registers) used to indicate that the address is faulty and/or should be bypassed.

For example, referring to FIGS. 6 and 8B, the memory controller 604 determines which near memory location the second far memory location is mapped to. In one such example, the memory controller calculates whether to bypass the near memory location using the near to far memory ratio. For example, the memory controller knows how many far memory locations are mapped to a given near memory location based on the mapping ratio. Thus, the memory controller can check whether the near memory location has been identified as faulty in the list based on the mapping ratio and mapping scheme. In one such example, the memory controller checks if lower address bits of the far memory location are in the list. In the example where the subsequent request is targeting the far memory location 812-2, the memory controller 604 determines that the far memory location 812-2 is mapped to the near memory location 810. The memory controller then checks the list 602 to determine whether or not information identifying the near memory location 810 is in the list 602to determine if the near memory location should be bypassed.

Referring again to FIG. 7, if the near memory location is in the list 602, the method involves bypassing the near memory location and sending the subsequent request to the far memory for servicing when the near memory address is identified as faulty, at block 710. For example, referring to FIGS. 6 and 8B, the memory controller bypasses the near memory 806 and directly accesses the requested data at the far memory location 812-2. In one example, bypassing the near memory location can be achieved by returning a miss for a fetch attempt to the near memory location when the near memory location is in the list 602, regardless of whether the requested data is stored at the near memory location. In other words, even if the fetch to near memory would have resulted in a hit, the memory controller logic (e.g., the 2LM control logic 228) returns a miss to cause near memory to be bypassed and force the data to be accessed in the far memory. In another example, bypassing the near memory location involves skipping the attempt to fetch from near memory (rather than forcing or faking a miss).

In one example, the memory controller 604 indicates a successful completion of the request to firmware despite the error at the near memory location. In one such example, the firmware provides a log to an operating system to indicate successful completion of the request to the far memory location, preventing offlining of the far memory location (or offlining of any other far memory locations mapped to the near memory location). However, the memory controller can keep track of the number of times the near memory location is bypassed and trigger further action when the count exceeds a threshold. For example, the memory controller can track a count of accesses to a near memory location in the list 602 and provide a notification to the firmware when the count of accesses to a near memory location in the list 602 exceeds the threshold. For example, the memory controller 604 includes a bypass count 603 to track the number of times a near memory location has been bypassed due to its presence in the list 602. In one such example, further action can be taken to prevent performance issues due to a high number of accesses to the far memory. In one such example, a performance counter is defined to count such transactions (e.g., requests that result in bypassing a faulty near memory location), and when the count exceeds a threshold, the memory controller notifies a data center manager for bad FRU (Field Replaceable Unit) isolation. In one such example, the memory controller provides information (e.g., addresses or other identifying information) based on the list to identify the faulty unit. In another example, when the count exceeds a threshold, the memory controller can inform the firmware to cause the far memory locations to be offlined (e.g., in accordance with examples described herein, such as the examples in FIGS. 3-5). Thus, the technique described in FIGS. 6, 7, and 8A-8B filter and inhibit access to the faulty memory in the hierarchy. While removing software complexity, the scheme described in FIGS. 6, 7, and 8A-8B would have the benefit of offlining zero pages with little performance penalty.

Thus, the techniques described herein enhance platform reliability and server uptime by avoiding accesses to a faulty memory location. In one example, the solutions described with respect to FIGS. 3-5 ensure that faulty memory location is not accessed by pro-actively offlining all possible mappings. The techniques described with respect to FIGS. 6, 7, and 8A- 8B prevent accesses to known faulty near memory locations by maintaining a list of such locations and bypassing the faulty near memory location.

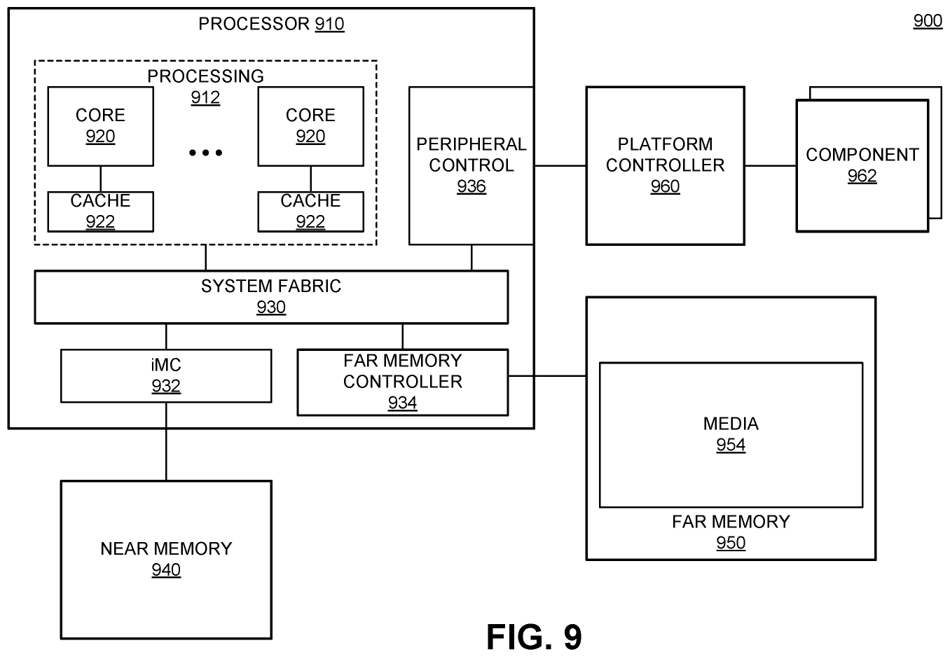

FIG. 9 is a block diagram of an example of a system with a memory subsystem having near memory and far memory with an integrated near memory controller and an integrated far memory controller. System 900 provides one example of a system in accordance with system 200 of FIG. 2.

System 900 represents components of a multilevel memory system. System 900 specifically illustrates an integrated memory controller and integrated far memory controller. The integrated controllers are integrated onto a processor die or in a processor SOC package, or both.

Processor 910 represents an example of a processor die or a processor SOC package. Processor 910 includes processing units 912, which can include one or more cores 920 to perform the execution of instructions. In one example, cores 920 include processor side cache 922, which will include cache control circuits and cache data storage. Cache 922 can represent any type of processor side cache. In one example, individual cores 920 include local cache resources 922 that are not shared with other cores. In one example, multiple cores 920 share cache resources 922. In one example, individual cores 920 include local cache resources 922 that are not shared, and multiple cores 920 include shared cache resources. It is to be understood that in the system shown, processor side cache 922 may store both data and metadata on-die.

In one example, processor 910 includes system fabric 930 to interconnect components of the processor system. System fabric 930 can be or include interconnections between processing components 912, peripheral control 936, one or more memory controllers such as integrated memory controller (iMC) 932 and far memory controller 934, 110 controls (not specifically shown), graphics subsystem (not specifically shown), or other components. System fabric 930 enables the exchange of data signals among the components. While system fabric 930 is generically shown connecting the components, it will be understood that system 900 does not necessarily illustrate all component interconnections. System fabric 930 can represent one or more mesh connections, a central switching mechanism, a ring connection, a hierarchy of fabrics, or other topology.

In one example, processor 910 includes one or more peripheral controllers 936 to connect off resource to peripheral components or devices. In one example, peripheral control 936 represents hardware interfaces to platform controller 960, which includes one or more components or circuits to control interconnection in a hardware platform or motherboard of system 900 to interconnect peripherals to processor 910. Components 962 represent any type of chip or interface or hardware element that couples to processor 910 via platform controller 960.

In one example, processor 910 includes iMC 932, which specifically represents control logic to connect to near memory 940. In one example, near memory 940 is what is traditionally considered the main memory of system 900. The main memory refers to a memory resource accessed when a cache miss occurs on a last level of cache 922. iMC 932 can include hardware circuits and software/firmware control logic.

In one example, near memory 940 represents a volatile memory resource. The memory 940 can be in accordance with standards such as: DDR4 (Double Data Rate version 4, initial specification published in September 2012 by JEDEC (Joint Electronic Device Engineering Council)), DDR4 E (DDR version 4), LPDDR3 (Low Power DDR version 3, JESD209-3B, August 2013 by JEDEC), LPDDR4 (LPDDR version 4, JESD209-4, originally published by JEDEC in August 2014), WIO2 (Wide Input/Output version 2, JESD229-2 originally published by JEDEC in August 2014), HBM (High Bandwidth Memory, JESD325, originally published by JEDEC in October 2013), DDR5 (DDR version 5, JESD79-5A, published October 2021), DDR version 6 (DDR6) (currently under draft development), LPDDR5, HBM2E, HBM3, and HBM-PIM, or others or combinations of memory technologies, and technologies based on derivatives or extensions of such specifications. The specification for LPDDR6 is currently under development. The JEDEC standards are available at www.jedec.org.

In one example, processor 910 includes far memory controller 934, which represents control logic to control access to far memory 950. Far memory 950 represents a memory resource that has an access time longer than the access time to near memory 940. In one example, far memory 950 includes a nonvolatile memory resource. Far memory controller 934 can include hardware circuits and software/firmware control logic. Both iMC 932 and far memory controller 934 can include scheduling logic to manage access to their respective memory resources. Far memory 950 includes media 954, which represents a storage media where far memory 950 stores data for system 900.

In one example, near memory 940 includes DRAM memory module or modules as main memory. In one example, far memory 950 includes a 3DXP memory. Thus, media 954 can be or include 3DXP memory, which is understood to have slower, but comparable, read times as compared to DRAM, and significantly slower write times as compared to DRAM. However, 3DXP is nonvolatile and therefore does not need to be refreshed like DRAM, allowing a lower standby power. A memory subsystem in accordance with system 900 can include 3DXP far memory 950 and a DRAM-based near memory 940. Overall power usage will be improved, and access performance should be comparable.

In place of 3DXP, other memory technologies such as phase change memory (PCM) or other nonvolatile memory technologies could be used. Nonlimiting examples of nonvolatile memory may include any or a combination of: solid state memory, storage devices that use chalcogenide phase change material (e.g., chalcogenide glass), byte addressable nonvolatile memory devices, ferroelectric memory, silicon-oxide-nitride-oxide-silicon (SONOS) memory, polymer memory (e.g., ferroelectric polymer memory), ferroelectric transistor random access memory (Fe-TRAM) ovonic memory, nanowire memory, electrically erasable programmable read-only memory (EEPROM), other various types of non-volatile random access memories (RAMs), magnetic storage memory, or any other non-volatile memory. In some examples, 3D crosspoint memory may comprise a transistor-less stackable cross point architecture in which memory cells sit at the intersection of wordlines and bitlines and are individually addressable and in which bit storage is based on a change in bulk resistance.

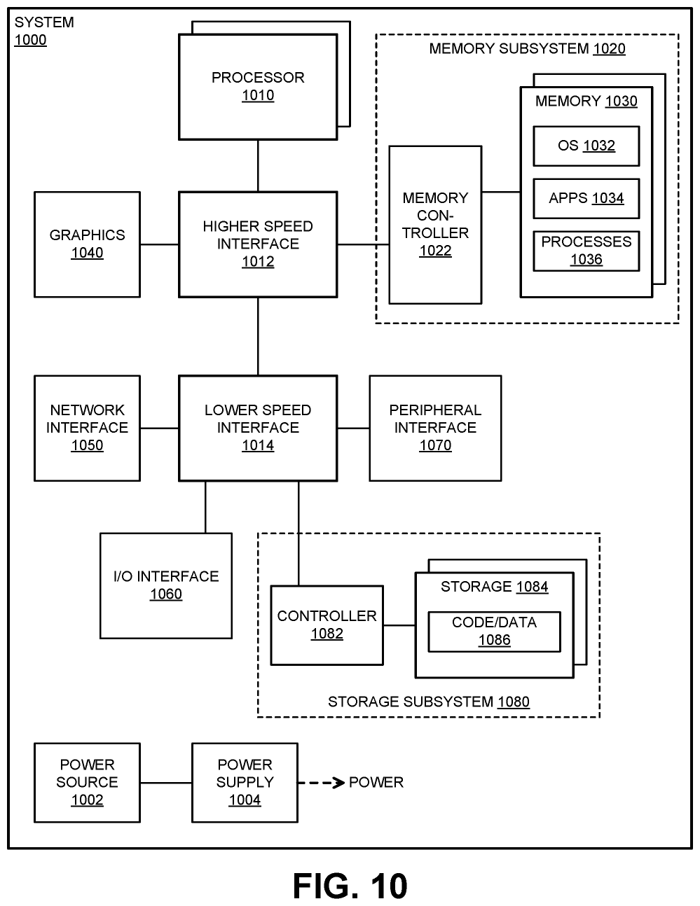

FIG. 10 is a block diagram of an example of a computing system in which multilevel memory error management techniques can be implemented. System 1000 represents a computing device in accordance with any example herein, and can be a laptop computer, a desktop computer, a tablet computer, a server, a gaming or entertainment control system, embedded computing device, or other electronic device. System 1000 provides an example of a system in accordance with system 200.

More specifically, processor 1010 and a host OS executed by the processor can represent a host, with memory resources in memory subsystem 1020 or memory resources in storage subsystem 1080 as the memory device.

System 1000 includes processor 1010 can include any type of microprocessor, central processing unit (CPU), graphics processing unit (GPU), processing core, or other processing hardware, or a combination, to provide processing or execution of instructions for system 1000. Processor 1010 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or a combination of such devices.

In one example, system 1000 includes interface 1012 coupled to processor 1010, which can represent a higher speed interface or a high throughput interface for system components that need higher bandwidth connections, such as memory subsystem 1020 or graphics interface components 1040. Interface 1012 represents an interface circuit, which can be a standalone component or integrated onto a processor die. Interface 1012 can be integrated as a circuit onto the processor die or integrated as a component on a system on a chip. Where present, graphics interface 1040 interfaces to graphics components for providing a visual display to a user of system 1000. Graphics interface 1040 can be a standalone component or integrated onto the processor die or system on a chip. In one example, graphics interface 1040 can drive a high definition (HD) display that provides an output to a user. In one example, the display can include a touchscreen display. In one example, graphics interface 1040 generates a display based on data stored in memory 1030 or based on operations executed by processor 1010 or both.

Memory subsystem 1020 represents the main memory of system 1000 and provides storage for code to be executed by processor 1010, or data values to be used in executing a routine. Memory subsystem 1020 can include one or more memory devices 1030 such as read- only memory (ROM), flash memory, one or more varieties of random access memory (RAM) such as DRAM, or other memory devices, or a combination of such devices. Memory 1030 stores and hosts, among other things, operating system (OS) 1032 to provide a software platform for execution of instructions in system 1000. Additionally, applications 1034 can execute on the software platform of OS 1032 from memory 1030. Applications 1034 represent programs that have their own operational logic to perform execution of one or more functions. Processes 1036 represent agents or routines that provide auxiliary functions to OS 1032 or one or more applications 1034 or a combination. OS 1032, applications 1034, and processes 1036 provide software logic to provide functions for system 1000. In one example, memory subsystem 1020 includes memory controller 1022, which is a memory controller to generate and issue commands to memory 1030. It will be understood that memory controller 1022 could be a physical part of processor 1010 or a physical part of interface 1012. For example, memory controller 1022 can be an integrated memory controller, integrated onto a circuit with processor 1010, such as integrated onto the processor die or a system on a chip.

While not specifically illustrated, it will be understood that system 1000 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or other bus, or a combination.

In one example, system 1000 includes interface 1014, which can be coupled to interface 1012. Interface 1014 can be a lower speed interface than interface 1012. In one example, interface 1014 represents an interface circuit, which can include standalone components and integrated circuitry. In one example, multiple user interface components or peripheral components, or both, couple to interface 1014. Network interface 1050 provides system 1000 the ability to communicate with remote devices (e.g., servers or other computing devices) over one or more networks. Network interface 1050 can include an Ethernet adapter, wireless interconnection components, cellular network interconnection components, USB (universal serial bus), or other wired or wireless standards-based or proprietary interfaces. Network interface 1050 can exchange data with a remote device, which can include sending data stored in memory or receiving data to be stored in memory.

In one example, system 1000 includes one or more input/output (I/O) interface(s) 1060. I/O interface 1060 can include one or more interface components through which a user interacts with system 1000 (e.g., audio, alphanumeric, tactile/touch, or other interfacing). Peripheral interface 1070 can include any hardware interface not specifically mentioned above. Peripherals refer generally to devices that connect dependently to system 1000. A dependent connection is one where system 1000 provides the software platform or hardware platform or both on which operation executes, and with which a user interacts.

In one example, system 1000 includes storage subsystem 1080 to store data in a nonvolatile manner. In one example, in certain system implementations, at least certain components of storage 1080 can overlap with components of memory subsystem 1020. Storage subsystem 1080 includes storage device(s) 1084, which can be or include any conventional medium for storing large amounts of data in a nonvolatile manner, such as one or more magnetic, solid state, or optical based disks, or a combination. Storage 1084 holds code or instructions and data 1086 in a persistent state (i.e., the value is retained despite interruption of power to system 1000). Storage 1084 can be generically considered to be a “memory,” although memory 1030 is typically the executing or operating memory to provide instructions to processor 1010. Whereas storage 1084 is nonvolatile, memory 1030 can include volatile memory (i.e., the value or state of the data is indeterminate if power is interrupted to system 1000). In one example, storage subsystem 1080 includes controller 1082 to interface with storage 1084. In one example, controller 1082 is a physical part of interface 1014 or processor 1010, or can include circuits or logic in both processor 1010 and interface 1014.

Power source 1002 provides power to the components of system 1000. More specifically, power source 1002 typically interfaces to one or multiple power supplies 1004 in system 1000 to provide power to the components of system 1000. In one example, power supply 1004 includes an AC to DC (alternating current to direct current) adapter to plug into a wall outlet. Such AC power can be renewable energy (e.g., solar power) power source 1002. In one example, power source 1002 includes a DC power source, such as an external AC to DC converter. In one example, power source 1002 or power supply 1004 includes wireless charging hardware to charge via proximity to a charging field. In one example, power source 1002 can include an internal battery or fuel cell source.

As discussed above, in some embodiment the processors illustrated herein may comprise Other Processing Units (collectively termed XPUs). Examples of XPUs include one or more of Graphic Processor Units (GPUs) or General Purpose GPUs (GP-GPUs), Tensor Processing Units (TPUs), Data Processing Units (DPUs), Infrastructure Processing Units (IPUs), Artificial Intelligence (AI) processors or AI inference units and/or other accelerators, FPGAs and/or other programmable logic (used for compute purposes), etc. While some of the diagrams herein show the use of CPUs, this is merely exemplary and non-limiting. Generally, any type of XPU may be used in place of a CPU in the illustrated embodiments. Moreover, as used in the following claims, the term “processor” is used to generically cover CPUs and various forms of XPUs.

While various embodiments described herein use the term System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).

The following are examples of error mitigation techniques for multilevel memory.

Example 1: A memory controller including: input/output (I/O) interface circuitry to communicatively couple the memory controller with a near memory and a far memory, and hardware logic to: detect an error at a near memory location in response to a request to access a far memory location mapped to the near memory location, in response to detection of the error at the near memory location, store information to identify the near memory location as faulty, receive a subsequent request to access a second far memory location mapped to the same near memory location, check the stored information to determine whether the near memory location to which the second far memory location is mapped is faulty, and bypass the near memory location when the near memory location is identified as faulty and send the subsequent request to the second far memory location.

Example 2: The memory controller of example 1, wherein: the hardware logic to identify the near memory location as faulty is to: store the information indicative of the near memory location in a list of faulty near memory locations.

Example 3: The memory controller of examples 1 or 2, wherein: the hardware logic is to store the information in one or more registers.

Example 4: The memory controller of any of examples 1-3, wherein: the hardware logic to bypass the near memory location is to: return a miss for a fetch attempt to the near memory location when the near memory location is identified as faulty even when requested data is stored at the near memory location.

Example 5: The memory controller of any of examples 1-3, wherein: the hardware logic to bypass the near memory location is to: skip an attempt to fetch from the near memory location when the near memory location is identified as faulty.

Example 6: The memory controller of any of examples 1-5, wherein: the hardware logic is to indicate successful completion of the request to firmware despite the error at the near memory location.

Example 7: The memory controller of any of examples 1-6, wherein: the firmware is to provide a log to an operating system to indicate successful completion of the request to the far memory location, preventing offlining of the far memory location.

Example 8: The memory controller of any of examples 1-7, wherein: the hardware logic is to: track a count of accesses to a near memory location identified as faulty, and provide a notification when the count of accesses to the near memory location in the list exceeds a threshold.

Example 9: The memory controller of any of examples 1-8, wherein: the I/O interface circuitry is to communicatively couple the memory controller with the near memory via a controller for the near memory and communicatively couple the memory controller with the far memory via a second controller for the far memory.

Example 10: A system including: a memory hierarchy including a near memory and a far memory, wherein multiple locations in the far memory are mapped to a single location in the near memory, and a memory controller to: store a near memory location in a list in response to detection of an error at the near memory location, the error encountered in response to a request to access a far memory location mapped to the near memory location, receive a subsequent request to access a second far memory location mapped to the same near memory location, check the list for the near memory location to which the second far memory location is mapped, and bypass the near memory location when the near memory location is in the list and send the subsequent request to the second far memory location.

Example 11: The system of example 10, wherein: the memory controller to bypass the near memory location is to: return a miss for a fetch attempt to the near memory location when the near memory location is in the list even when requested data is stored at the near memory location.

Example 12: The system of examples 10 or 11, wherein: the memory controller includes a two-level memory (2LM) memory controller.

Example 13: The system of example 12, wherein: the 2LM memory controller is coupled with a first controller for the near memory and a second controller for the far memory.

Example 14: The system of any of examples 10-13, wherein: the memory controller includes control logic for both the near memory and the far memory.

Example 15: The system of any of examples 10-14, further including one or more of: a processor including or coupled with the memory controller, a display, and a power source.

Example 16: A method including receiving notification of a memory error at a near memory location in response to a request to access a far memory location mapped to the near memory location, determining other far memory locations mapped to the same near memory location, and offlining the far memory location and the other far memory locations mapped to the near memory location.

Example 17: The method of example 16, wherein: determining the other far memory locations includes: checking an address map, by firmware, for the other far memory locations mapped to the near memory location, and offlining the far memory location and the other far memory locations includes: providing, by the firmware, an error log to an operating system to identify the far memory location and the other far memory locations to trigger offlining pages at those locations in the far memory by the operating system.

Example 18: The method of example 16, wherein: offlining pages at those locations in the far memory by the operating system includes copying data at the far memory location and the other far memory locations to other locations in the far memory, and making the far memory location and the other far memory locations unavailable for access.

Example 19: The method of example 16, wherein determining the other far memory locations includes: checking an address map, by an operating system, for the other far memory locations mapped to the near memory location, and offlining the far memory location and the other far memory locations includes: copying data at the far memory location and the other far memory locations to other locations in the far memory, and making the far memory location and the other far memory locations unavailable for access.

Example 20: The method of example 19, further including determining a mapping ratio of near memory locations to far memory locations, and determining a number of pages to offline based on the mapping ratio.

Example 21: A non-transitory machine-readable medium having instructions stored thereon configured to be executed on one or more processors to perform a method in accordance with any of examples 16-20.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Note that actions triggered in response to a value being greater than or lower than a threshold can mean greater than or equal to, or lower than or equal to, and are design choices. Thus, it is understood that the terms “greater than” or “lower than” a threshold are intended to encompass embodiments in which a trigger occurs in response to the value being “greater than or equal to” or “lower than or equal to.”

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

The hardware design embodiments discussed above may be embodied within a semiconductor chip and/or as a description of a circuit design for eventual targeting toward a semiconductor manufacturing process. In the case of the later, such circuit descriptions may take of the form of a (e.g., VHDL or Verilog) register transfer level (RTL) circuit description, a gate level circuit description, a transistor level circuit description or mask description or various combinations thereof. Circuit descriptions are typically embodied on a computer readable storage medium (such as a CD-ROM or other type of storage technology).

Besides what is described herein, various modifications can be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A memory controller comprising:
input/output (I/O) interface circuitry to communicatively couple the memory controller with a near memory and a far memory; and
hardware logic to:
detect an error at a near memory location in response to a request to access a far memory location mapped to the near memory location,
in response to detection of the error at the near memory location, store information to identify the near memory location as faulty,
receive a subsequent request to access a second far memory location mapped to the same near memory location,
check the stored information to determine whether the near memory location to which the second far memory location is mapped is faulty, and
bypass the near memory location when the near memory location is identified as faulty and send the subsequent request to the second far memory location.

2. The memory controller of claim 1, wherein:
the hardware logic to identify the near memory location as faulty is to:
store the information indicative of the near memory location in a list of faulty near memory locations.

3. The memory controller of claim 2, wherein:
the hardware logic is to store the information in one or more registers.

4. The memory controller of claim 1, wherein:
the hardware logic to bypass the near memory location is to:
return a miss for a fetch attempt to the near memory location when the near memory location is identified as faulty even when requested data is stored at the near memory location.

5. The memory controller of claim 1, wherein:
the hardware logic to bypass the near memory location is to:
skip an attempt to fetch from the near memory location when the near memory location is identified as faulty.

6. The memory controller of claim 1, wherein:
the hardware logic is to indicate successful completion of the request to firmware despite the error at the near memory location.

7. The memory controller of claim 6, wherein:
the firmware is to provide a log to an operating system to indicate successful completion of the request to the far memory location, preventing offlining of the far memory location.

8. The memory controller of claim 1, wherein:
the hardware logic is to:
track a count of accesses to a near memory location identified as faulty, and
provide a notification when the count of accesses to the near memory location in the list exceeds a threshold.

9. The memory controller of claim 1, wherein:
the I/O interface circuitry is to communicatively couple the memory controller with the near memory via a controller for the near memory and communicatively couple the memory controller with the far memory via a second controller for the far memory.

10. A system comprising:
a memory hierarchy including a near memory and a far memory, wherein multiple locations in the far memory are mapped to a single location in the near memory; and
a memory controller to:
store a near memory location in a list in response to detection of an error at the near memory location, the error encountered in response to a request to access a far memory location mapped to the near memory location,
receive a subsequent request to access a second far memory location mapped to the same near memory location,
check the list for the near memory location to which the second far memory location is mapped, and
bypass the near memory location when the near memory location is in the list and send the subsequent request to the second far memory location.

11. The system of claim 10, wherein:
the memory controller to bypass the near memory location is to:
return a miss for a fetch attempt to the near memory location when the near memory location is in the list even when requested data is stored at the near memory location.

12. The system of claim 10, wherein:
the memory controller includes a two-level memory (2LM) memory controller.

13. The system of claim 12, wherein:
the 2LM memory controller is coupled with a first controller for the near memory and a second controller for the far memory.

14. The system of claim 10, wherein:
the memory controller includes control logic for both the near memory and the far memory.

15. The system of claim 10, further comprising:
one or more of: a processor including or coupled with the memory controller, a display, and a power source.

16. A non-transitory machine-readable medium having instructions stored thereon configured to be executed on one or more processors to perform a method, the method comprising:
receiving notification of a memory error at a near memory location in response to a request to access a far memory location mapped to the near memory location;
determining other far memory locations mapped to the same near memory location; and
offlining the far memory location and the other far memory locations mapped to the near memory location.

17. The non-transitory machine-readable medium of claim 16, wherein:
determining the other far memory locations includes: checking an address map, by firmware, for the other far memory locations mapped to the near memory location; and
offlining the far memory location and the other far memory locations includes: providing, by the firmware, an error log to an operating system to identify the far memory location and the other far memory locations to trigger offlining pages at those locations in the far memory by the operating system.

18. The non-transitory machine-readable medium of claim 17, wherein:
offlining pages at those locations in the far memory by the operating system includes:
copying data at the far memory location and the other far memory locations to other locations in the far memory, and making the far memory location and the other far memory locations unavailable for access.

19. The non-transitory machine-readable medium of claim 16, wherein:
determining the other far memory locations includes: checking an address map, by an operating system, for the other far memory locations mapped to the near memory location; and
offlining the far memory location and the other far memory locations includes:
copying data at the far memory location and the other far memory locations to other locations in the far memory, and making the far memory location and the other far memory locations unavailable for access.

20. The non-transitory machine-readable medium of claim 19, further comprising:
determining a mapping ratio of near memory locations to far memory locations; and
determining a number of pages to offline based on the mapping ratio.
